(19) United States
(12) Patent Application Publication
(10) Pub. No.: US 2025/0351200 A1
(43) Pub. Date: Nov. 13, 2025

(54) UE-ASSISTED, NON-CELLULAR, WIRELESS CONNECTIONS FOR VEHICLES

(71) Applicant: Charter Communications Operating, LLC, St. Louis, MO (US)

(72) Inventors: Mohamed Daoud, Aurora, CO (US); Hany Heikal, Aurora, CO (US); Hossam Hmimy, Aurora, CO (US)

(73) Assignee: Charter Communications Operating, LLC, St. Louis, MO (US)

(21) Appl. No.: 18/658,252

(22) Filed: May 8, 2024

(51) Int. Cl. H04W 76/10; H04W 12/069; H04W 76/25; H04W 84/12

(52) U.S. Cl. CPC H04W 76/10; H04W 12/069; H04W 76/25; H04W 84/12

(57) ABSTRACT

User equipment (e.g., a cell phone) assists in establishing a non-cellular wireless (e.g., WiFi) connection for a vehicle. In some embodiments, the UE provides information about the network (e.g., SSID and credential/certificate) to the vehicle for use in establishing the connection. In other embodiments, the UE secures, retains, and uses a network certificate for the vehicle to establish the connection without providing the certificate to the vehicle. The embodiments facilitate and encourage the use of non-cellular wireless connections instead of possibly more-expensive and/or resource-limited cellular connections.

### BACKGROUND

### Field of the Disclosure

The present disclosure relates to non-cellular wireless connections for vehicles and, more specifically but not exclusively, to WiFi connections for vehicles.

### Description of the Related Art

This section introduces aspects that may help facilitate a better understanding of the disclosure. Accordingly, the statements of this section are to be read in this light and are not to be understood as admissions about what is prior art or what is not prior art.

Many current vehicles require connectivity to their manufacturers' servers and other online servers for telemetry data, entertainment, navigation, and computer-vision model training. Such vehicles come with pre-installed SIM cards for cellular connectivity and are also WiFi-capable. The SIM card enables automatic connectivity to a cellular network without the user's involvement. At the same time, the vehicle's WiFi modem requires the user to choose a WiFi network and enter the proper credentials. This results in many users not connecting their vehicles to WiFi at all or not connecting their vehicles to the WiFi network that is currently available to them.

This is a challenge for both network operators and vehicle manufacturers. The vehicle manufacturers prefer to transfer data over WiFi since it's free (or at least cheaper than transferring data over cellular). Some vehicle manufacturers buffer their vehicles' data transmission and reception until the vehicle is connected to WiFi to avoid cellular fees. From the perspective of a network operator that runs both cellular and WiFi networks, the preference might be to transfer data over WiFi to avoid cellular data congestion and running out of capacity due to the scarcity of the cellular spectrum compared to the WiFi spectrum.

Small numbers of vehicles are connected to WiFi because users are not aware of how to connect them or not aware that there is an open WiFi network they could use or simply don't care since users pay a flat fee for vehicle cellular connectivity, while vehicle manufacturers carry the burden of any excess cellular charges.

### SUMMARY

Problems in the prior art are addressed in accordance with the principles of the present disclosure by techniques for enabling cell phones and other UEs to assist in establishing WiFi connections for vehicles.

In at least one embodiment of the present disclosure, user equipment (UE) establishes (i) a non-cellular wireless connection between the UE and a non-cellular wireless network and (ii) a connection between the UE and a vehicle. The UE uses (i) the non-cellular wireless connection with the non-cellular wireless network and (ii) the connection with the vehicle to assist in establishing a non-cellular wireless connection between the vehicle and the non-cellular wireless network.

In at least one other embodiment of the present disclosure, a vehicle establishes a connection between the vehicle and a UE, and the vehicle uses the connection with the UE to receive assistance from the UE in establishing a non-cellular wireless connection between the vehicle and a non-cellular wireless network.

In at least one other embodiment of the present disclosure, a non-cellular wireless network establishes a non-cellular wireless connection between the non-cellular wireless network and a UE, and the non-cellular wireless network uses the non-cellular wireless connection with the UE to assist the UE in establishing a non-cellular wireless connection between a vehicle and the non-cellular wireless network.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a flow diagram of an algorithm for establishing WiFi connections for vehicles according to certain embodiments of the present disclosure;

FIG. 2 is a message flow diagram according to a first technique by which a UE assists in establishing a WiFi connection between a vehicle and the WiFi network to which the UE is currently connected;

FIG. 3 is a message flow diagram according to a second technique by which a UE assists in establishing a WiFi connection between a vehicle and the WiFi network to which the UE is currently connected;

FIG. 4 is a message flow diagram according to a third technique by which a UE assists in establishing a WiFi connection between a vehicle and the WiFi network to which the UE is currently connected; and

FIG. 5 is a simplified hardware block diagram of a generic node that can be used to implement any of the corresponding hardware in the UEs, vehicles, and/or WiFi networks of the present disclosure.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

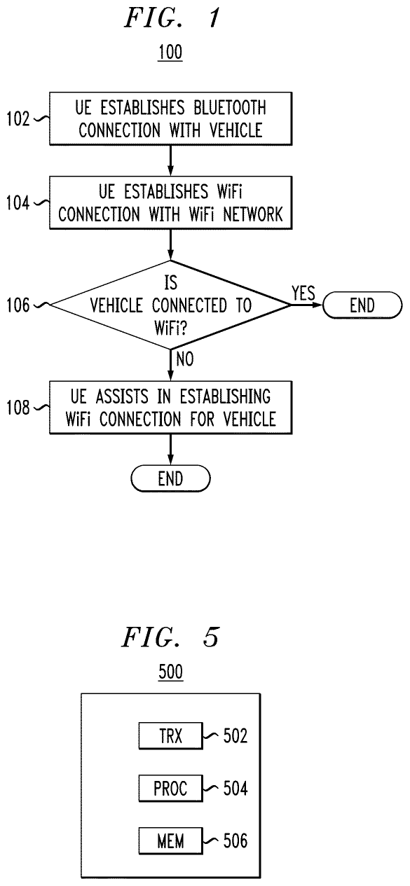

FIG. 1 is a flow diagram of an algorithm 100 for establishing WiFi connections for vehicles according to certain embodiments of the present disclosure. The algorithm 100 involves user equipment (UE), such as (without limitation) a cell phone, assisting in the establishment of a WiFi connection between a vehicle and a WiFi network. Note that the algorithm 100 requires the vehicle to be located within range of the WiFi network to which the UE is currently connected, which WiFi network may be the UE's home network or other, available WiFi network to which the UE connects.

In step 102, the UE establishes a connection with the vehicle. In a typical embodiment, this connection is a wireless Bluetooth Low Energy (BLE) connection employing Generic Attribute (GATT) profiles, but, in other embodiments, the connection may be any other suitable wireless or even wired connection between a UE and a vehicle, including cellular LTE or 5G connections.

In step 104, which may be before, during, or after step 102, the UE establishes a WiFi connection with the access point (AP) of a WiFi network. Although the technology is described in the context of WiFi connections, those skilled in the art will understand that this connection may be another other suitable type of non-cellular, wireless connection between a UE and an available non-cellular wireless network.

In step 106, the UE determines whether the vehicle is already connected to a WiFi network. This is typically accomplished by the UE querying the vehicle via the Bluetooth connection, although other suitable techniques may be available. If the UE determines that the vehicle does have an existing WiFi connection, then the UE does nothing. If, however, the UE determines that the vehicle does not have an existing WiFi connection, then, in step 108, the UE assists in the establishment of a WiFi connection between the vehicle and the WiFi network to which the UE is currently connected. There are different techniques by which a UE can assist in establishing such a WiFi connection. Some of those techniques are described below.

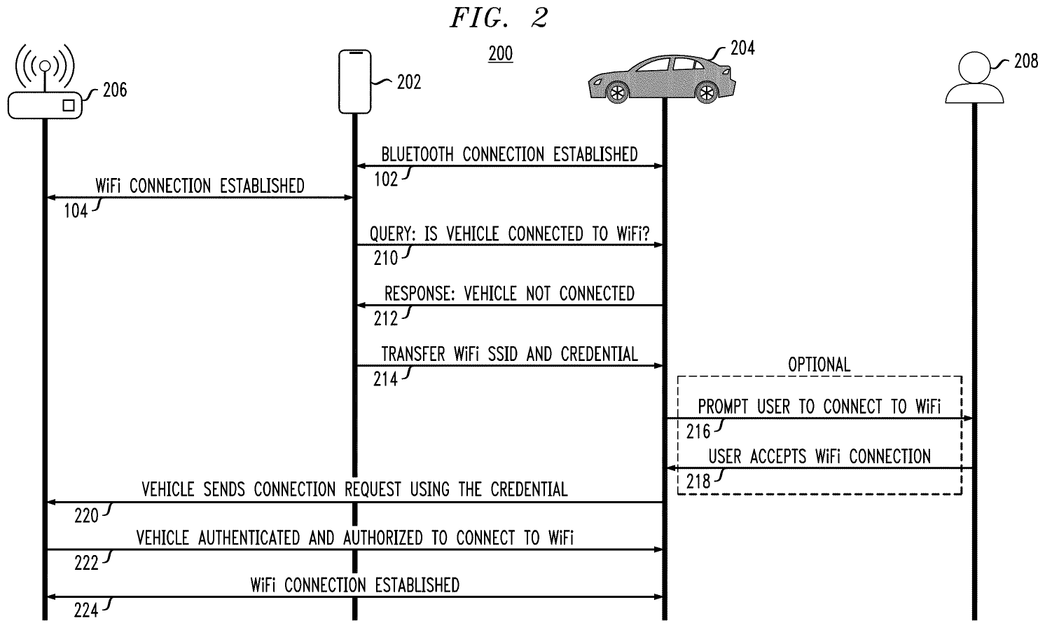

FIG. 2 is a message flow diagram according to a first technique 200 by which a UE 202 assists in establishing a WiFi connection between a vehicle 204 and the WiFi network 206 to which the UE 202 is currently connected. This first technique 200 is for WiFi networks 206 that employ a WPA2/3 authentication method that requires the user 208 to enter a WiFi Protected Access (WPA) password. Note that, in typical situations, the user 208 is the person operating both the UE 202 and the vehicle 204.

As shown in FIG. 2, in steps 102 and 104 of FIG. 1, the UE 202 establishes both a Bluetooth connection with the vehicle 204 and a WiFi connection with the WiFi network 206 using conventional procedures.

In steps 210 and 212, the UE 202 determines that the vehicle 204 is not connected to any WiFi network, as in step 106 of FIG. 1. In particular, in step 210, the UE 202 transmits, via the Bluetooth connection to the vehicle 204, a query as to whether the vehicle 204 is currently connected to a WiFi network. In response, in step 212, the vehicle 204 transmits, via the Bluetooth connection to the UE 202, a response indicating that the vehicle 204 is not currently connected to a WiFi network.

In steps 214-224, the UE 202 performs step 108 of FIG. 1 to assist in establishing a WiFi connection for the vehicle 204 with the WiFi network 206 to which the UE 202 is currently connected. In particular, in step 214, the UE 202 transmits, via the Bluetooth connection to the vehicle 204, the service set identifier (SSID) and credential (i.e., WPA2/3 password) for the WiFi network 206. In some implementations, the UE 202 employs encryption algorithms to confidentially provide the SSID and credential to the vehicle 204 using the Bluetooth Attribute Protocol (ATT). Inherently, Bluetooth Low Energy (BLE) has four security levels:
1—Security Level 1: No security, no encryption, and no authentication
2—Security Level 2: Unauthenticated pairing with encryption
3—Security Level 3: Authenticated pairing with AES-CCM encryption
4—Security Level 4: Authenticated LE Secure Connections pairing with encryption, which uses ECDH and AES-CCM encryption.
   So, some suitable encryption algorithms the UE 202 could employ to confidentially provide the SSID and credential to the vehicle 204 using the Bluetooth Attribute Protocol (ATT) are (i) AES-CCM encryption and ECDH key agreement at the link layer and/or (ii) TLS or DTLS encryption and certificates at the application layer.

In step 216, the vehicle 204 presents the user 208 with the opportunity to connect the vehicle 204 to the identified WiFi network 206, e.g., using the vehicle display and/or playing an audio message. In step 218, the user 208 signals their agreement to have the vehicle 204 connect to that WiFi network 206. In some implementations, steps 216 and 218 are optional. For example, in some implementations, the vehicle 204 has a user-controllable setting to either require user confirmation (as in steps 216 and 218) or automatically connect to WiFi (thereby skipping steps 216 and 218).

In either case, in step 220, the vehicle 204 transmits a conventional WiFi connection request to the WiFi network 206 using the credential provided by the UE 202. In step 222, the WiFi network 206 authenticates and authorizes the vehicle 204 to connect to the WiFi network 206, and, in step 224, that WiFi connection is established between the vehicle 204 and the WiFi network 206.

After implementing the first technique 200, if the WiFi connection between the vehicle 204 and the WiFi network 206 is terminated or lost, since the vehicle 204 has the SSID and credential for the WiFi network 206, the vehicle 204 will have the ability to automatically reconnect with the WiFi network 206 like other similar WiFi-enabled devices as soon as the WiFi network 206 is once again available.

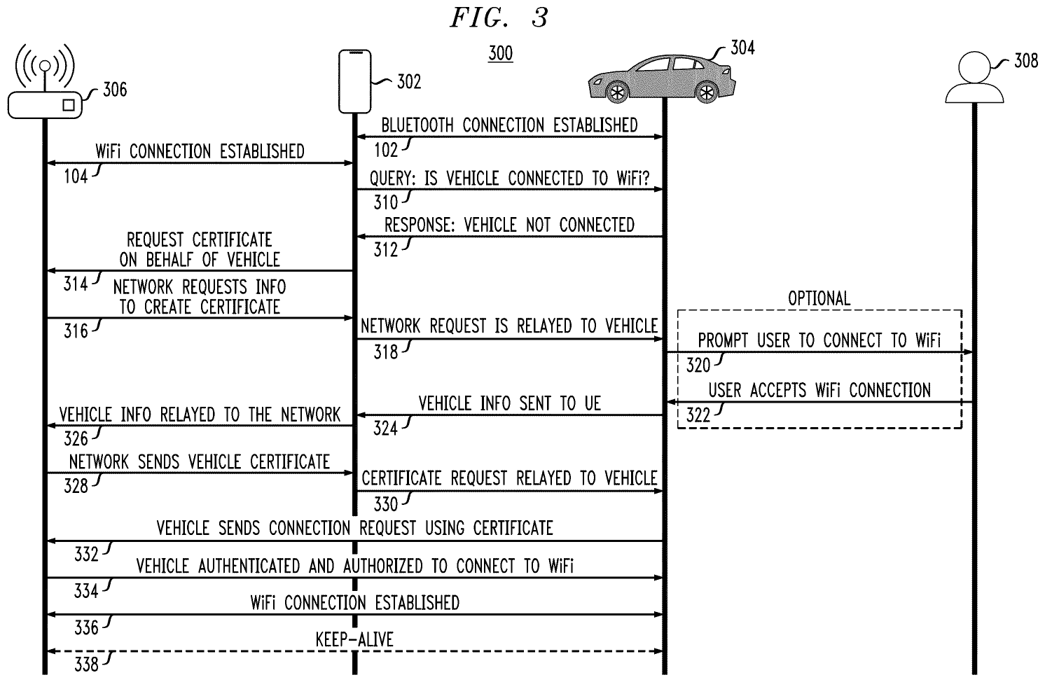

FIG. 3 is a message flow diagram according to a second technique 300 by which a UE 302 assists in establishing a WiFi connection between a vehicle 304 and the WiFi network 306 to which the UE 302 is currently connected. This second technique 300 is for WiFi networks 306 that employ Extensible Authentication Protocol-Transport Layer Security (EAP-TLS) certificates for authentication and authorization. In this second technique 300, the UE 302 assists in securing, for the vehicle 304, an EAP-TLS certificate that the vehicle 304 then uses to establish a WiFi connection with the WiFi network 306.

In FIG. 3, the UE 302, vehicle 304, WiFi network 306, and user 308 are respectively analogous to the UE 202, vehicle 204, WiFi network 206, and user 208 of FIG. 2, and steps 102, 104, 310, 312, 320, 322, 334, and 336 of FIG. 3 are respectively analogous to steps 102, 104, 210, 212, 216, 218, 222, and 224 of FIG. 2.

In step 314, after determining in step 312 that the vehicle 304 is not connected to any WiFi network, the UE 302 transmits, via the WiFi connection to the WiFi network 306, a request for an EAP-TLS certificate for the vehicle 304. In response, in step 316, the WiFi network 306 transmits, via the WiFi connection to the UE 302, a request for information, e.g., the vehicle's Media Access Control (MAC) address, needed to create the certificate. In step 318, the UE 302 relays that information request to the vehicle 304 via the Bluetooth connection. In response, potentially after steps 320 and 322 have been implemented, in step 324, the vehicle 304 transmits, via the Bluetooth connection to the UE 302, the requested vehicle information, which, in step 326, the UE 302 relays via the WiFi connection to the WiFi network 306.

In step 328, the WiFi network 306 generates and transmits, via the WiFi connection to the UE 302, the certificate for the vehicle 304, which, in step 330, the UE 302 relays via the Bluetooth connection to the vehicle 304. In step 332, the vehicle 304 uses the certificate to transmit, to the WiFi network 306, a conventional request for a WiFi connection.

As known in the art, in order to maintain the EAP-TLS WiFi connection between the vehicle 304 and the WiFi network 306 that is established in step 336, keep-alive messages are transmitted via that WiFi connection between the vehicle 304 and the WiFi network 306 as represented by step 338 of FIG. 3.

Note that, in some implementations of the second technique 300, steps 314 and 316 are omitted. In those implementations, after determining in step 312 that the vehicle 304 is not connected to any WiFi network, in step 318, the UE 302 proceeds immediately to transmit, via the Bluetooth connection to the vehicle 304, a request for the vehicle information needed for the certificate. In that case, after receiving the vehicle information in step 324, in a modified step 326, the UE 302 transmits, via the WiFi connection to the WiFi network 306, a request for the EAP-TLS certificate for the vehicle 304, where the request includes the necessary vehicle information, thereby essentially combining steps 314 and 326 of FIG. 3 in a single step.

Here, too, as with the first technique 200 of FIG. 2, after implementing the second technique 300, if the WiFi connection between the vehicle 304 and the WiFi network 306 is terminated or lost, since the vehicle 304 has the SSID and WiFi certificate for the WiFi network 306, the vehicle 304 will have the ability to automatically reconnect with the WiFi network 306 like other similar WiFi-enabled devices as soon as the WiFi network 306 is once again available.

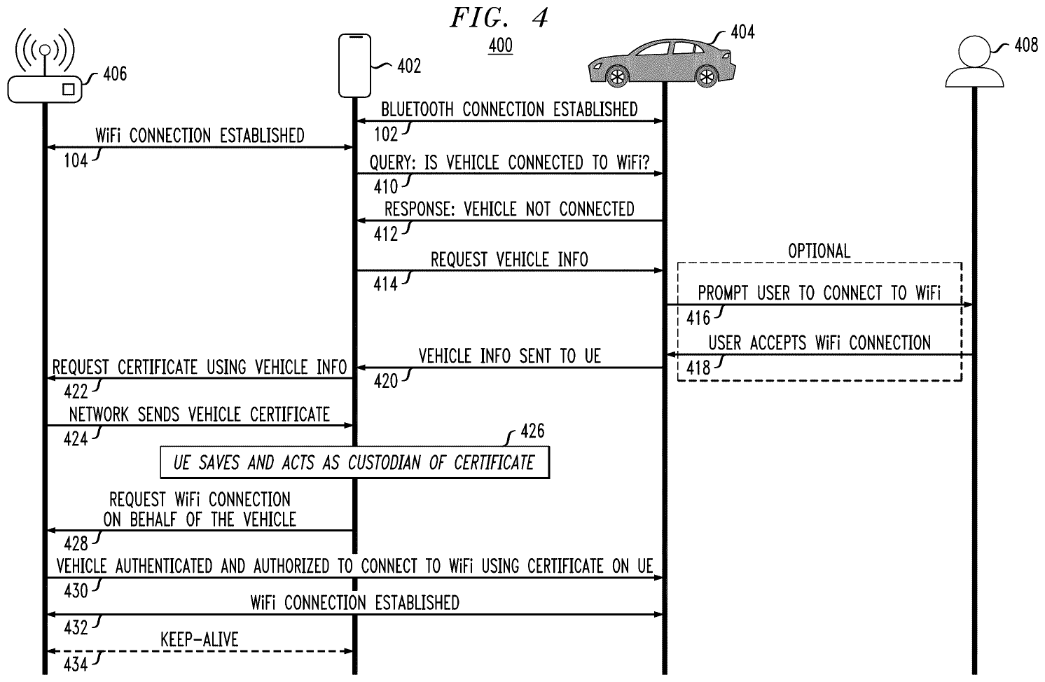

FIG. 4 is a message flow diagram according to a third technique 400 by which a UE 402 assists in establishing a WiFi connection between a vehicle 404 and the WiFi network 406 to which the UE 302 is currently connected. Like the second technique 300 of FIG. 3, this third technique 400 is for WiFi networks 406 that employ EAP-TLS certificates for authentication and authorization. Unlike the second technique 300, however, in this third technique 400, the UE 402 assists in securing, for the vehicle 404, an EAP-TLS certificate that is used to establish a WiFi connection between the vehicle 404 and the WiFi network 406, but where the EAP-TLS certificate is stored at the UE 402 and not sent to the vehicle 404, with the UE 402 acting as a WiFi certificate broker for the vehicle 404.

In FIG. 4, the UE 402, vehicle 404, WiFi network 406, and user 408 are respectively analogous to the UE 302, vehicle 304, WiFi network 306, and user 308 of FIG. 3, and steps 102, 104, 410, 412, 416, 418, 420, 424, 430, and 432 of FIG. 4 are respectively analogous to steps 102, 104, 310, 312, 320, 322, 324, 328, 334, and 336 of FIG. 3.

In step 414, the UE 402 transmits, via the Bluetooth connection to the vehicle 404, a request for the vehicle information without having to perform the analog of steps 314 and 316 of FIG. 3.

In step 422, the UE 402 transmits, via the WiFi connection to the WiFi network 406, a request for the EAP-TLS certificate. After receiving the certificate from the WiFi network 406 in step 424, in step 426, the UE 402 stores the certificate without forwarding it to the vehicle 404. As such, without the certificate, the vehicle 404 is not able to request a WiFi connection with the WiFi network 406. Instead, in step 428, on behalf of the vehicle 404, the UE 402 transmits, via the WiFi connection to the WiFi network 406, a request for a WiFi connection with the vehicle 404.

Since the vehicle 404 does not have the certificate, the keep-alive messages for maintaining the WiFi connection between the vehicle 404 and the WiFi network 406 are handled by the UE 402, which retains the certificate in the UE's local memory, as represented by step 434 of FIG. 4.

Unlike the first and second techniques 200 and 300 of FIGS. 2 and 3, after implementing the third technique 400, if the WiFi connection between the vehicle 404 and the WiFi network 406 is terminated or lost, since the vehicle 404 does not have the WiFi certificate for the WiFi network 406, the third technique 400 will need to be repeated into order to reconnect the vehicle 404 with the WiFi network 306.

FIG. 5 is a simplified hardware block diagram of a generic node 500 that can be used to implement any of the corresponding hardware in the UEs, vehicles, and/or WiFi networks of the present disclosure. As shown in FIG. 5, the node 500 includes (i) communication hardware (e.g., wireless transceivers (TRX)) 502 that supports communications with other nodes, (ii) one or more processors (e.g., CPU and/or GPU microprocessors) 504 that control the operations of the node 500 and/or process data within the node 500, and (iii) one or more memories (e.g., RAM, ROM) 506 that store code executed by the processors 504 and/or data generated and/or received by the node 500.

The first, second, and third techniques 200, 300, and 400 of FIGS. 2, 3, and 4, and other suitable techniques of the present disclosure may provide some or all of the following advantages:
Seamless, secure, and automated process for connecting vehicles to WiFi, enhancing user experience, and addressing connectivity challenges;
Simplifies the vehicle-to-WiFi connection process for users through multiple options;
Enhances user experience through automated and secure credential transfer;
Ensures efficient and reliable connectivity through intelligent Bluetooth-WiFi interaction with Easy Connect integration;
User Convenience: Simplifies the process for users by automatically connecting their vehicle to WiFi when their cell phone is connected, eliminating the need for manual input;
Cost Savings: Maximizes WiFi for data transfer, which can be less expensive or even free compared to cellular data, leading to potential cost savings for users and manufacturers;
WIFI monetization: Networks that charge for WIFI usage will be able to monetize automotive data traffic;
Improved Telemetry Data Handling: WiFi connection enables manufacturers to collect telemetry data efficiently, enhancing vehicle diagnostics, maintenance, and performance monitoring; and
Enhanced Entertainment and Navigation Services: Seamless WiFi connectivity contributes to a better experience for in-vehicle entertainment and navigation systems, since data can be transferred more quickly and reliably.

In certain embodiments, the present disclosure is a method for user equipment (UE) assisting in establishing a non-cellular wireless connection between a vehicle and a non-cellular wireless network, the method comprising the UE establishing a non-cellular wireless connection between the UE and the non-cellular wireless network; the UE establishing a connection between the UE and the vehicle; and the UE using (i) the non-cellular wireless connection with the non-cellular wireless network and (ii) the connection with the vehicle to assist in establishing the non-cellular wireless connection between the vehicle and the non-cellular wireless network.

In at least some of the above embodiments, at least one of (i) the non-cellular wireless connections are WiFi connections with a WiFi network and (ii) the connection between the UE and the vehicle is a Bluetooth Low Energy (BLE) connection.

In at least some of the above embodiments, prior to assisting in establishing the non-cellular wireless connection between the vehicle and the non-cellular wireless network, the UE determines that the vehicle does not have a non-cellular wireless connection with a non-cellular wireless network.

In at least some of the above embodiments, to assist in establishing the non-cellular wireless connection between the vehicle and the non-cellular wireless network, the UE transmits, to the vehicle, information about the non-cellular wireless network, wherein the information comprises (i) an identifier of the non-cellular wireless network and (ii) either a password or a certificate for the vehicle to connect to the non-cellular wireless network.

In at least some of the above embodiments, the UE transmits, to the vehicle, a request for information about the vehicle; the UE receives, from the vehicle, the information about the vehicle; the UE transmits, to the non-cellular wireless network, the information about the vehicle; the UE receives, from the non-cellular wireless network, the certificate; and the UE transmits, to the vehicle, the certificate.

In at least some of the above embodiments, to assist in establishing the non-cellular wireless connection between the vehicle and the non-cellular wireless network, (i) the UE acquires a certificate for the vehicle to connect to the non-cellular wireless network and (ii) the UE uses the certificate to establish the non-cellular wireless connection between the vehicle and the non-cellular wireless network without providing the certificate to the vehicle.

In at least some of the above embodiments, to acquire the certificate, (i) the UE transmits, to the vehicle, a request for information about the vehicle; (ii) the UE receives, from the vehicle, the information about the vehicle; (iii) the UE transmits, to the non-cellular wireless network, a request for the certificate with the vehicle information; (iv) the UE receives, from the WiFi network, the certificate; (v) the UE stores the certificate without transmitting the certificate to the vehicle; and (vi) the UE transmits, to the non-cellular wireless network, a request for the non-cellular wireless connection between the vehicle and the non-cellular wireless network, wherein the request includes information about the certificate.

In at least some of the above embodiments, the UE transmits, to the non-cellular wireless network, a series of keep-alive messages to maintain the non-cellular wireless connection between the vehicle and the non-cellular wireless network.

In certain other embodiments, the present disclosure is a method for establishing a non-cellular wireless connection between a vehicle and a non-cellular wireless network, the method comprising the vehicle establishing a connection between the vehicle and a UE; and the vehicle using the connection with the UE to receive assistance from the UE in establishing the non-cellular wireless connection between the vehicle and the non-cellular wireless network.

In at least some of the above embodiments, at least one of (i) the non-cellular wireless connection is a WiFi connection with a WiFi network and (ii) the connection between the vehicle and the UE is a BLE connection.

In at least some of the above embodiments, prior to establishing the non-cellular wireless connection between the vehicle and the non-cellular wireless network, the vehicle informs the UE that the vehicle does not have a non-cellular wireless connection with a non-cellular wireless network.

In at least some of the above embodiments, to receive assistance from the UE in establishing the non-cellular wireless connection between the vehicle and the non-cellular wireless network, (a) the vehicle receives, from the UE, information about the non-cellular wireless network, wherein the information comprises (i) an identifier of the non-cellular wireless network and (ii) either a password or a certificate for the vehicle to connect to the non-cellular wireless network and (b) the vehicle uses the information to establish the non-cellular wireless connection between the vehicle and the non-cellular wireless network.

In at least some of the above embodiments, prior to receiving the information about the non-cellular wireless network, (i) the vehicle receives, from the UE, a request for information about the vehicle and (ii) the vehicle transmits, to the UE, the information about the vehicle.

In certain other embodiments, the present disclosure is a method for establishing a non-cellular wireless connection between a vehicle and a non-cellular wireless network, the method comprising the non-cellular wireless network establishing a non-cellular wireless connection between the non-cellular wireless network and a UE; and the non-cellular wireless network using the non-cellular wireless connection with the UE to assist the UE in establishing the non-cellular wireless connection between the vehicle and the non-cellular wireless network.

In at least some of the above embodiments, the non-cellular wireless connections are WiFi connections with a WiFi network.

In at least some of the above embodiments, the non-cellular wireless network receives, from the UE, a request for a certificate for the vehicle to connect to the non-cellular wireless network; and the non-cellular wireless network generates and transmits the certificate to the UE.

In at least some of the above embodiments, the non-cellular wireless network receives, from the UE, the request for the certificate without information about the vehicle; the non-cellular wireless network transmits, to the UE, a request for the information about the vehicle; the non-cellular wireless network receives, from the UE, the information about the vehicle; and the non-cellular wireless network generates and transmits the certificate to the UE.

In at least some of the above embodiments, the non-cellular wireless network receives, from the UE, the request for the certificate with information about the vehicle; and the non-cellular wireless network generates and transmits the certificate to the UE.

In at least some of the above embodiments, the non-cellular wireless network receives, from the vehicle, a request for the non-cellular wireless connection with the vehicle using the certificate.

In at least some of the above embodiments, the non-cellular wireless network receives, from the UE, a request for the non-cellular wireless connection with the vehicle using the certificate.

In at least some of the above embodiments, the non-cellular wireless network receives, from the UE, a series of keep-alive messages to maintain the non-cellular wireless connection between the vehicle and the non-cellular wireless network.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for user equipment (UE) assisting in establishing a non-cellular wireless connection between a vehicle and a non-cellular wireless network, the method comprising:
the UE establishing a non-cellular wireless connection between the UE and the non-cellular wireless network;
the UE establishing a connection between the UE and the vehicle; and
the UE using (i) the non-cellular wireless connection with the non-cellular wireless network and (ii) the connection with the vehicle to assist in establishing the non-cellular wireless connection between the vehicle and the non-cellular wireless network.

2. The method of claim 1, wherein at least one of:
the non-cellular wireless connections are WiFi connections with a WiFi network; and
the connection between the UE and the vehicle is a Bluetooth Low Energy (BLE) connection.

3. The method of claim 1, wherein, prior to assisting in establishing the non-cellular wireless connection between the vehicle and the non-cellular wireless network, the UE determines that the vehicle does not have a non-cellular wireless connection with a non-cellular wireless network.

4. The method of claim 1, wherein, to assist in establishing the non-cellular wireless connection between the vehicle and the non-cellular wireless network, the UE transmits, to the vehicle, information about the non-cellular wireless network, wherein the information comprises (i) an identifier of the non-cellular wireless network and (ii) either a password or a certificate for the vehicle to connect to the non-cellular wireless network.

5. The method of claim 4, wherein:
the UE transmits, to the vehicle, a request for information about the vehicle;
the UE receives, from the vehicle, the information about the vehicle;
the UE transmits, to the non-cellular wireless network, the information about the vehicle;
the UE receives, from the non-cellular wireless network, the certificate; and
the UE transmits, to the vehicle, the certificate.

6. The method of claim 1, wherein, to assist in establishing the non-cellular wireless connection between the vehicle and the non-cellular wireless network:
the UE acquires a certificate for the vehicle to connect to the non-cellular wireless network; and
the UE uses the certificate to establish the non-cellular wireless connection between the vehicle and the non-cellular wireless network without providing the certificate to the vehicle.

7. The method of claim 6, wherein, to acquire the certificate:
the UE transmits, to the vehicle, a request for information about the vehicle;
the UE receives, from the vehicle, the information about the vehicle;
the UE transmits, to the non-cellular wireless network, a request for the certificate with the vehicle information;
the UE receives, from the WiFi network, the certificate;
the UE stores the certificate without transmitting the certificate to the vehicle; and
the UE transmits, to the non-cellular wireless network, a request for the non-cellular wireless connection between the vehicle and the non-cellular wireless network, wherein the request includes information about the certificate.

8. The method of claim 7, wherein the UE transmits, to the non-cellular wireless network, a series of keep-alive messages to maintain the non-cellular wireless connection between the vehicle and the non-cellular wireless network.

9. A UE comprising:
a memory; and
at least one processor, coupled to the memory and operative to cause the UE to:
establish a non-cellular wireless connection between the UE and a non-cellular wireless network;
establish a connection between the UE and a vehicle; and
use (i) the non-cellular wireless connection with the non-cellular wireless network and (ii) the connection with the vehicle to assist in establishing a non-cellular wireless connection between the vehicle and the non-cellular wireless network.

10. A method for establishing a non-cellular wireless connection between a vehicle and a non-cellular wireless network, the method comprising:
the vehicle establishing a connection between the vehicle and a UE; and
the vehicle using the connection with the UE to receive assistance from the UE in establishing the non-cellular wireless connection between the vehicle and the non-cellular wireless network.

11. The method of claim 10, wherein at least one of:
the non-cellular wireless connection is a WiFi connection with a WiFi network; and
the connection between the vehicle and the UE is a BLE connection.

12. The method of claim 10, wherein, prior to establishing the non-cellular wireless connection between the vehicle and the non-cellular wireless network, the vehicle informs the UE that the vehicle does not have a non-cellular wireless connection with a non-cellular wireless network.

13. The method of claim 10, wherein, to receive assistance from the UE in establishing the non-cellular wireless connection between the vehicle and the non-cellular wireless network:
the vehicle receives, from the UE, information about the non-cellular wireless network, wherein the information comprises (i) an identifier of the non-cellular wireless network and (ii) either a password or a certificate for the vehicle to connect to the non-cellular wireless network; and
the vehicle uses the information to establish the non-cellular wireless connection between the vehicle and the non-cellular wireless network.

14. The method of claim 13, wherein, prior to receiving the information about the non-cellular wireless network:
the vehicle receives, from the UE, a request for information about the vehicle; and
the vehicle transmits, to the UE, the information about the vehicle.

15. A vehicle comprising:
a memory; and
at least one processor, coupled to the memory and operative to cause the vehicle to:
establish a connection between the vehicle and a UE; and
use the connection with the UE to receive assistance from the UE in establishing a non-cellular wireless connection between the vehicle and a non-cellular wireless network.

16. A method for establishing a non-cellular wireless connection between a vehicle and a non-cellular wireless network, the method comprising:
the non-cellular wireless network establishing a non-cellular wireless connection between the non-cellular wireless network and a UE; and
the non-cellular wireless network using the non-cellular wireless connection with the UE to assist the UE in establishing the non-cellular wireless connection between the vehicle and the non-cellular wireless network.

17. The method of claim 16, wherein the non-cellular wireless connections are WiFi connections with a WiFi network.

18. The method of claim 16, wherein:
the non-cellular wireless network receives, from the UE, a request for a certificate for the vehicle to connect to the non-cellular wireless network; and
the non-cellular wireless network generates and transmits the certificate to the UE.

19. The method of claim 18, wherein:
the non-cellular wireless network receives, from the UE, the request for the certificate without information about the vehicle;
the non-cellular wireless network transmits, to the UE, a request for the information about the vehicle;
the non-cellular wireless network receives, from the UE, the information about the vehicle; and
the non-cellular wireless network generates and transmits the certificate to the UE.

20. The method of claim 18, wherein:
the non-cellular wireless network receives, from the UE, the request for the certificate with information about the vehicle; and
the non-cellular wireless network generates and transmits the certificate to the UE.

21. The method of claim 18, wherein the non-cellular wireless network receives, from the vehicle, a request for the non-cellular wireless connection with the vehicle using the certificate.

22. The method of claim 18, wherein the non-cellular wireless network receives, from the UE, a request for the non-cellular wireless connection with the vehicle using the certificate.

23. The method of claim 22, wherein the non-cellular wireless network receives, from the UE, a series of keep-alive messages to maintain the non-cellular wireless connection between the vehicle and the non-cellular wireless network.

24. A non-cellular wireless network comprising:
a memory; and
at least one processor, coupled to the memory and operative to cause the non-cellular wireless network to:
establish a non-cellular wireless connection between the non-cellular wireless network and a UE; and
use the non-cellular wireless connection with the UE to assist the UE in establishing a non-cellular wireless connection between a vehicle and the non-cellular wireless network.
